(19) United States
(12) Patent Application Publication
(10) Pub. No.: US 2025/0088970 A1
(43) Pub. Date: Mar. 13, 2025

(54) DYNAMIC OPEN LOOP POWER CONTROL PARAMETER SWITCHING BETWEEN EMBB AND URLLC IN UNIFIED TCI FRAMEWORK

(71) Applicant: Lenovo (Beijing) Limited, Beijing (CN)

(72) Inventors: Bingchao Liu, Beijing (CN); Lingling Xiao, Beijing (CN); Haiming Wang, Beijing (CN)

(73) Assignee: Lenovo (Beijing) Limited, Beijing (CN)

(21) Appl. No.: 18/726,719

(22) PCT Filed: Jan. 20, 2022
(86) PCT No.: PCT/CN2022/072874

§ 371 Date: Jul. 3, 2024

(51) Int. Cl. H04W 52/10; H04W 72/1268; H04W 72/231

(52) U.S. Cl. CPC H04W 52/10; H04W 72/1268; H04W 72/231

(57) ABSTRACT

Methods and apparatuses for dynamic open loop power control parameter switching between eMBB and URLLC in unified TCI framework are disclosed. In one embodiment, a UE comprises a processor; and a receiver coupled to the processor, wherein the processor is configured to receive, via the receiver, a configuration of one or more P0-PUSCH-sets each of which can be associated with a UL or joint TCI state; and determine a P0 value for a PUSCH transmission associated with an indicated UL or joint TCI state according to an OLPCPSI field contained in the DCI scheduling the PUSCH transmission.

### FIELD

The subject matter disclosed herein generally relates to wireless communications, and more particularly relates to methods and apparatuses for dynamic open loop power control parameter switching between eMBB (Enhanced Mobile Broadband) and URLLC (Ultra-reliable and Low Latency Communications) in unified TCI framework.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Pathloss reference signal (PL-RS), reference signal (RS), Physical Uplink Shared Channel (PUSCH), Downlink Control Information (DCI), Ultra-reliable and Low Latency Communications (URLLC), Transmission Configuration Indicator or Transmission Configuration Indication (TCI), Enhanced Mobile Broadband (eMBB), Physical Uplink Control Channel (PUCCH), component carrier (CC), control resource set (CORESET), Physical Downlink Shared Channel (PDSCH), Physical Downlink Control Channel (PDCCH), quasi-colocation (QCL), Sounding Reference Signal (SRS), Demodulation Reference Signal (DM-RS), band width part (BWP), Medium Access Control (MAC), MAC control element (MAC CE), TS (Technical Specification) (TS refers to 3GPP Technical Specification in this disclosure), Least Significant Bit (LSB), Most Significant Bit (MSB), open-loop power control parameter set indication (OLPCPSI), transmission reception point (TRP), Channel State Information Reference Signal (CSI-RS).

In NR Release 15, one or more SRI-PUSCH-PowerControls, each of which is a set of open loop power control parameters including P0 (which configures the target received power of the UE signal), alpha (i.e. path-loss compensation factor) and PL-RS (a DL RS used to compute the DL channel path-loss) for PUSCH transmission (that are all power control parameters for PUSCH transmission), are configured for a UE. Each SRI-PUSCH-PowerControl is mapped to a value (i.e. SRI codepoint) of the SRI field. It means that the SRI field of the DCI scheduling a PUSCH transmission indicates the value (i.e. SRI codepoint) that is mapped to the power control parameters including P0, alpha and PL-RS for the PUSCH transmission.

In NR Release 16, in order to improve the coverage of URLLC traffic, additional p0 values are configured for each SRI codepoint, and an open-loop power control parameter set indication field can be configured to be contained in DCI format 0_1 or 0_2 to indicate to the UE which P0 value should be used for the scheduled PUSCH transmission.

In NR Release 17, unified TCI framework is introduced. The TX beam for PUSCH transmission is directly determined by the UL TCI state or joint TCI state indicated by DCI format 1_1 or 1_2. In addition, it has been agreed that a set of power control parameters including P0, alpha, PL-RS and closed loop index for PUSCH transmission for eMBB can be associated with each UL TCI state or joint TCI state.

However, it is yet unknown on how to support dedicated open loop power control for URLLC.

This disclosure targets supporting open loop power control for URLLC in unified TCI framework and the corresponding UE behavior, especially the dynamic open loop power control switching between eMBB and URLLC.

### BRIEF SUMMARY

Methods and apparatuses for dynamic open loop power control parameter switching between eMBB and URLLC in unified TCI framework are disclosed.

In one embodiment, a UE comprises a processor; and a receiver coupled to the processor, wherein the processor is configured to receive, via the receiver, a configuration of one or more P0-PUSCH-sets each of which can be associated with a UL or joint TCI state; and determine a P0 value for a PUSCH transmission associated with an indicated UL or joint TCI state according to an OLPCPSI field contained in the DCI scheduling the PUSCH transmission. The processor may be further configured to receive, via the receiver, an association of one P0-PUSCH-set to the indicated UL or joint TCI state.

In one embodiment, the association is contained in an RRC signaling.

In another embodiment, the association is contained in a MAC CE. The MAC CE may associate one P0-PUSCH-set to each of the activated UL or joint TCI state(s), and the indicated UL or joint TCI state is indicated from the activated UL or joint TCI state(s). An example MAC CE may include TCI codepoint fields of 8 bits, including N non-zero bit(s), each non-zero TCI codepoint field identifies a TCI codepoint that can be associated with an activated UL or joint TCI state, where N is from 1 to 8; N TCI state ID fields, each of which identifies a UL or joint TCI state associated with one non-zero TCI codepoint field; N P_{N} fields, each of which indicates whether one P0-PUSCH-SetId field corresponding to one P_{N} field is present; and P0-PUSCH-SetId fields, each of which indicates a P0-PUSCH-Set associated with one UL or joint TCI state identified by one TCI state ID field.

In yet another embodiment, each TCI codepoint activated with a UL or joint TCI state is associated with one P0-PUSCH-Set based on a predetermined order. Accordingly, the one P0-PUSCH-Set associated with the TCI codepoint is associated with the UL or joint TCI state activated to the TCI codepoint.

One or two values can be configured in each P0-PUSCH-Set. In some embodiment, if olpc-ParameterSetDCI-0-1 and olpc-ParameterSetDCI-0-2 are configured to be 1 bit, one value is configured in each P0-PUSCH-Set; and if olpc-ParameterSetDCI-0-1 and olpc-ParameterSetDCI-0-2 are configured to be 2 bits, two values are configured in each P0-PUSCH-Set. In particular, the P0 value is determined by the P0 value contained in p0_Alpha_CLIdPUSCHSet that is associated with the indicated UL or joint TCI state if a value of the OLPCPSI field is ‘0’ or ‘00’, a first value configured in the P0-PUSCH-Set associated with the indicated UL or joint TCI state if a value of the OLPCPSI field is ‘1’ or ‘01’ and the indicated UL or joint TCI state is associated with a P0-PUSCH-Set, a first value configured in the P0-PUSCH-Set with a lowest p0-PUSCH-SetID value if a value of the OLPCPSI field is ‘1’ or ‘01’ and the indicated UL or joint TCI state is not associated with any P0-PUSCH-Set, a second value configured in the P0-PUSCH-Set associated with the indicated UL or joint TCI state if a value of the OLPCPSI field is ‘10’ and the indicated UL or joint TCI state is associated with a P0-PUSCH-Set, and a second value configured in the P0-PUSCH-Set with a lowest p0-PUSCH-SetID value if a value of the OLPCPSI field is ‘10’ and the indicated UL or joint TCI state is not associated with any P0-PUSCH-Set.

In another embodiment, a method at a UE comprises receiving a configuration of one or more P0-PUSCH-sets each of which can be associated with a UL or joint TCI state; and determining a P0 value for a PUSCH transmission associated with an indicated UL or joint TCI state according to an OLPCPSI field contained in the DCI scheduling the PUSCH transmission.

In still another embodiment, a base unit comprises a processor; and a transmitter coupled to the processor, wherein the processor is configured to transmit, via the transmitter, a configuration of one or more P0-PUSCH-sets each of which can be associated with a UL or joint TCI state; and determine a P0 value for a PUSCH transmission associated with an indicated UL or joint TCI state according to an OLPCPSI field contained in the DCI scheduling the PUSCH transmission.

In yet another embodiment, a method of a base unit comprises transmitting a configuration of one or more P0-PUSCH-sets each of which can be associated with a UL or joint TCI state; and determining a P0 value for a PUSCH transmission associated with an indicated UL or joint TCI state according to an OLPCPSI field contained in the DCI scheduling the PUSCH transmission.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an RRC signaling for configuring P0-PUSCH-Set;

FIG. 2 illustrates an example RRC signaling associating a P0-PUSCH-Set with a TCI state;

FIG. 3 illustrates an example of MAC CE to associate each activated TCI codepoint with a P0-PUSCH-Set;

FIG. 4 is a schematic flow chart diagram illustrating an embodiment of a method;

FIG. 5 is a schematic flow chart diagram illustrating an embodiment of another method; and

FIG. 6 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

In NR Release 17 unified TCI framework, joint DL/UL TCI or separate DL/UL TCI can be configured for a cell by RRC signaling.

When separate DL/UL TCI is configured, the DL TCI state for DL reception and UL TCI state for UL transmission are separately indicated. For UL TCI state, the source reference signal in the UL TCI provides a reference for determining UL TX spatial filter at least for dynamic-grant or configured-grant based PUSCH transmission and all of dedicated PUCCH resources, which are the PUCCH resources in RRC-connected mode, in a CC. For DL TCI state, the source reference signal(s) (one source reference signal is contained if only the higher layer parameter qcl-Type1 is configured, and two source reference signals are contained if both the higher layer parameter qcl-Type1 and the higher layer parameter qcl_Type2 are configured) in the DL TCI provides QCL information at least for UE-dedicated reception on PDCCH and all the PDSCHs in a CC. Each CORESET is configured by a set time-frequency resource for PDCCH reception. In this situation, a PL-RS is associated with the indicated UL TCI state for path loss calculation. UL power control parameters other than PL-RS (e.g. set of P0, alpha and closed loop index) for PUSCH, PUCCH and SRS may also be associated with the indicated UL TCI state.

When joint DL/UL TCI is configured, both UL TCI state for UL transmission and DL TCI state for DL reception are determined by a single indicated joint DL/UL TCI state. When the joint DL/UL TCI state is configured, a joint TCI refers to at least a common source reference RS used for determining both the DL QCL information and the UL TX spatial filter. For example, the UL TX beam and the DL RX beam are both determined by the QCL-TypeD RS configured in the indicated joint DL/UL TCI state. In this situation, a PL-RS is associated with the indicated joint DL/UL TCI state for path loss calculation. UL power control parameters other than PL-RS (e.g. set of P0, alpha and closed loop index) for PUSCH, PUCCH and SRS may also be associated with the indicated joint DL/UL TCI state.

A brief introduction of the TCI state is provided as follows:

The UE can be configured with a list of up to M TCI-State configurations to decode PDSCH according to a detected PDCCH with DCI intended for the UE and the given serving cell, where M depends on the UE capability. The TCI-state is configured by the following RRC signaling:

The IE TCI-State associates one or two DL reference signals with a corresponding quasi-colocation (QCL) type.

TCI-State information element

| | |
|---|---|
| TCI-State ::= | SEQUENCE { |
| tci-StateId | TCI-Stateld, |
| qcl-Type1 | QCL-Info, |
| qcl-Type2 | QCL-Info |
| ... | |
| } | |
| QCL-Info ::= | SEQUENCE { |
| cell | ServCellIndex |
| bwp-Id | BWP-Id |
| referenceSignal | CHOICE { |
| csi-rs | NZP-CSI-RS-ResourceId, |
| ssb | SSB-Index |
| }, | |
| qcl-Type | ENUMERATED {typeA, typeB, typeC, typeD}, |
| ... | |
| } | |

Each TCI-State contains parameters for configuring a quasi co-location (QCL) relationship between one or two downlink reference signals and the DM-RS ports of the PDSCH, the DM-RS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs.

The quasi co-location types corresponding to each DL RS are given by the higher layer parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The UE receives an activation command used to map up to 8 TCI states to the codepoints of the DCI field ‘Transmission Configuration Indication’ in one DL BWP of a serving cell. When a UE supports two TCI states in a codepoint of the DCI field ‘Transmission Configuration Indication’ to determine different TX beams for UL transmission, the UE may receive an activation command, the activation command is used to map up to 8 combinations of one or two TCI states to the codepoints of the DCI field ‘Transmission Configuration Indication’, where the one or two TCI states are both used for UL TX beam determination.

In the following disclosure, it is assumed one UL TCI state (if separate DL/UL TCI is configured) or one joint DL/UL TCI state (if joint DL/UL TCI is configured) can be activated or indicated to determine the TX beam for UL transmission (e.g. PUSCH transmission). Incidentally, joint DL/UL TCI state can be abbreviated as joint TCI state, and UL TCI state or joint TCI state can be referred to as UL or joint TCI state hereinafter. Either the UL TCI state or the joint TCI state is selected from a TCI state pool consisting multiple TCI states configured to a UE in a BWP of a cell.

In particular, a MAC CE can activate one UL or joint TCI state to each of one or multiple TCI codepoints. If only one TCI codepoint is activated with one UL or joint TCI state, the one UL or joint TCI state is used to determine the TX beam for UL transmission (e.g. PUSCH transmission). If multiple (e.g. 2 to 8) TCI codepoints are activated, one TCI codepoint is indicated by a DCI. It means that the one UL or joint TCI state activated to the indicated one TCI codepoint is used to determine the TX beam for UL transmission (e.g. PUSCH transmission).

In the following description, the following expressions are used:

A TCI state pool: it consists of multiple TCI states configured to a UE in a BWP of a cell.

A UL or joint TCI state: it refers to a TCI state used to determine the TX beam for UL transmission selected from the TCI state pool.

An activated UL or joint TCI state: it refers to a UL or joint TCI state activated to any TCI codepoint.

An indicated UL or joint TCI state: it refers to the UL or joint TCI state activated to the only one activated TCI codepoint or the UL or joint TCI state activated to the one TCI codepoint indicated by a DCI.

The following parameters are defined:

p0_Alpha_CLIdPUSCHSet: UL PC parameters other than PL-RS (Set of P0, alpha and closed loop index) for PUSCH transmission.

p0_Alpha_CLIdPUCCHSet: UL PC parameters other than PL-RS (Set of P0, alpha and closed loop index) for PUCCH transmission.

p0_Alpha_CLIdSRSSet: UL PC parameters other than PL-RS (Set of P0, alpha and closed loop index) for SRS transmission.

Multiple p0_Alpha_CLIdPUSCHSets, each of which has a set index (e.g. p0_Alpha_CLIdPUSCHSetId), multiple p0_Alpha_CLIdPUCCHSets, each of which has a set index (e.g. p0_Alpha_CLIdPUCCHSetId) and multiple p0_Alpha_CLIdSRSSets, each of which has a set index (e.g. p0_Alpha_CLIdSRSSetId) shall be configured for a UE in a BWP of a cell. Each UL or joint TCI state can be associated with one p0_Alpha_CLIdPUSCHSet, one p0_Alpha_CLIdPUCCHSet and one p0_Alpha_CLIdSRSSet.

It has been agreed that the p0_Alpha_CLIdPUSCHSet associated with the UL or joint TCI state is applicable for eMBB (Enhanced Mobile Broadband). It means that the P0 value contained in the p0_Alpha_CLIdPUSCHSet is applicable for eMBB PUSCH transmission.

In order to support URLLC (Ultra-reliable and Low Latency Communications) PUSCH transmission, additional P0 set for PUSCH (e.g., P0-PUSCH-Set) can be configured. The P0-PUSCH-Set can be used for URLLC PUSCH transmission. It means that the P0 value(s) configured in the P0-PUSCH-Set can be used for URLLC PUSCH transmission.

Each P0-PUSCH-Set can be configured by the RRC signaling illustrated in FIG. 1. Each P0-PUSCH-Set contains one or two P0 values depending on the value of maxNrofP0-PUSCH-Set-r16 which indicates the maximum number of P0 values per P0-PUSCH-Set.

One or two P0 values (i.e. P0-PUSCH values) can be configured in one P0-PUSCH-Set. For example, if the open-loop power control parameter set indication (OLPCPSI) field contained in DCI format 0_1 or 02 (e.g. olpc-ParameterSetDCI-0-1 and olpc-ParameterSetDCI-0-2) is one bit, one P0 value can be configured in one P0-PUSCH-Set. If the OLPCPSI field contained in DCI format 0_1 or 0_2 is two bits, two P0 values (e.g. a first P0 value and a second P0 value) can be configured in one P0-PUSCH-Set.

A configuration of a P0-PUSCH-SetList containing one or multiple (e.g. up to 8) P0-PUSCH-Sets can be configured for a UE in a BWP of a cell. Each P0-PUSCH-Set is identified by a P0-PUSCH-SetId.

Each activated UL or joint TCI state can be associated with one P0-PUSCH-Set.

Three different options are provided to establish the association between one P0-PUSCH-Set and one activated UL or joint TCI state.

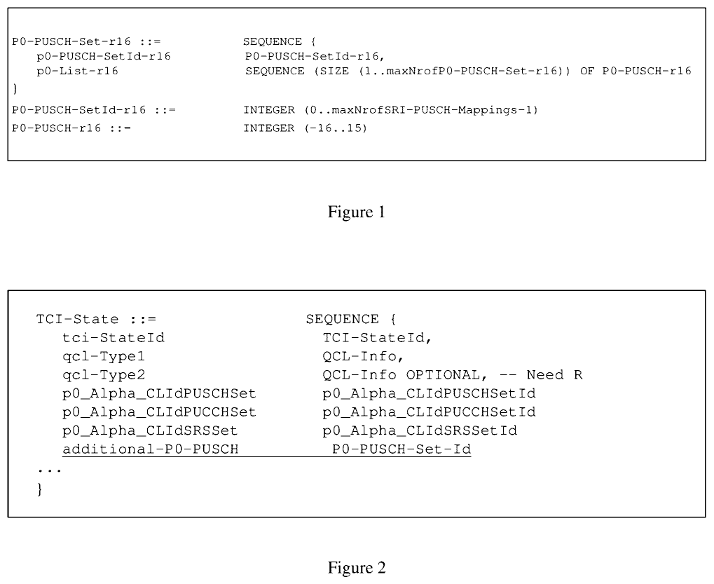

Option 1: Each TCI state in the TCI state pool may be associated with a P0-PUSCH-Set by RRC signaling, e.g. by an example RRC signaling illustrated in FIG. 2. Accordingly, when any TCI state in the TCI state pool is activated to a TCI codepoint, the activated UL or joint TCI state is associated with a P0-PUSCH-Set.

Option 2: Each activated UL or joint TCI state may be associated with a P0-PUSCH-Set by MAC CE.

For example, each activated UL or joint TCI state may be associated with a P0-PUSCH-Set by a MAC CE. The MAC CE may contain each activated UL or joint TCI state identified by an TCI state ID field and its associated P0-PUSCH-Set identified by a P0-PUSCH-SetId field.

Since each activated TCI codepoint is activated with one UL or joint TCI state, the association of the activated UL or joint TCI state with P0-PUSCH-Set can be determined from an association of the activated TCI codepoint (to which the UL or joint TCI state is activated) with P0-PUSCH-Set. That is, for another example, each TCI codepoint (e.g. each activated TCI codepoint) can be associated with a P0-PUSCH-Set by a MAC CE. Accordingly, the activated UL or joint TCI state is associated with the P0-PUSCH-Set associated with the TCI codepoint to which the UL or joint TCI state is activated.

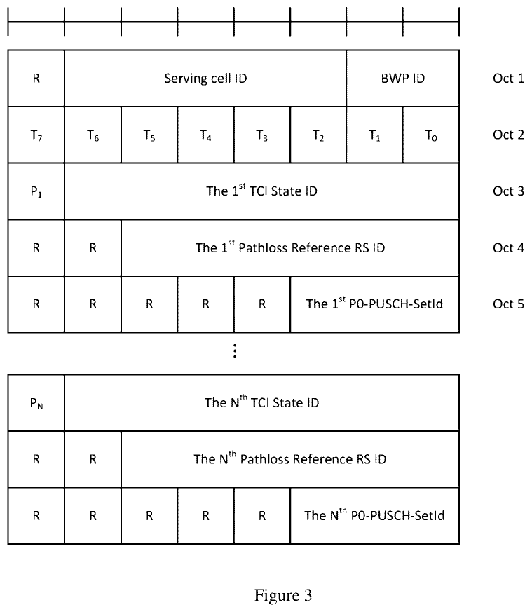

FIG. 3 illustrates the other example of the MAC CE to associate each TCI codepoint (e.g. each TCI codepoint activated with a UL or joint TCI state) with a P0-PUSCH-Set.

In FIG. 3, the following fields are contained in the MAC CE:

Serving Cell ID (with 5 bits): the Serving Cell ID field indicates the identity of the Serving Cell for which the MAC CE applies.

BWP ID (with 2 bits): the BWP ID field indicates a BWP of the cell indicated by the Serving Cell ID field for which the MAC CE applies.

Tᵢ (i=0 to 7) (each with 1 bit): each Tᵢ field identifies a TCI codepoint (e.g. TCI codepoint 000, 001, 010, 011, 100, 101, 110 and 111). Tᵢ field being set to 0 means that no UL or joint TCI state is mapped to (i.e. associated with or activated to) the TCI codepoint identified by Tᵢ. Tᵢ field being set to 1 means that a UL or joint TCI state (and a pathloss reference RS and, if existing, a P0-PUSCH-Set) is mapped to (i.e. associated with or activated to) the TCI codepoint identified by Tᵢ. That is, the UL or joint TCI state identified by the 1^{st} TCI state ID is mapped to the TCI codepoint identified by the first non-zero Tᵢ field (from the least significant bit (LSB) to the most significant bit (MSB) of Oct 2 in FIG. 3). For example, if T₀ is set 0 and T₁ is set 1, the UL or joint TCI state identified by the 1^{st} TCI state ID is mapped to the TCI codepoint identified by Tᵢ(e.g. TCI codepoint 001).

The N^{th} TCI state ID (N is the number of non-zero Tᵢ fields) (each with 7 bits): Each the N^{th} TCI state ID field identifies a UL or joint TCI state mapped to the TCI codepoint identified by the N^{th} non-zero Tᵢ field (from the LSB to the MSB of Oct 2 in FIG. 3).

The N^{th} pathloss reference RS ID (N is the number of non-zero Tᵢ field) (each with 6 bits): Each the N^{th} pathloss reference RS ID field identifies a pathloss reference RS mapped to the TCI codepoint identified by the N^{th} non-zero Tᵢ field (from the LSB to the MSB of Oct 2 in FIG. 3).

P_{N} (N is the number of non-zero Tᵢ fields) (each with 1 bit): The P_{N} field indicates whether the P0-PUSCH-Set identified by the N^{th} P0-PUSCH-SetId field is associated with the TCI codepoint identified by the N^{th} non-zero Tᵢ field, i.e. associated with the UL or joint TCI state identified by the N^{th} TCI state ID field. Only when P_{N}=1, the N^{th} P0-PUSCH-SetId field is present. If P_{N}=0, the N^{th} P0-PUSCH-SetId field is replaced with R fields, and the UE shall ignore the N^{th} P0-PUSCH-SetId field.

The N^{th} P0-PUSCH-SetId (N is the number of non-zero Tᵢ fields) (each with 3 bits): if existing (i.e. when P_{N}=1), the N^{th} P0-PUSCH-SetId field identifies the P0-PUSCH-Set associated with the TCI codepoint identified by the N^{th} non-zero Tᵢ field, i.e. associated with the UL or joint TCI state identified by the N^{th} TCI state ID field.

R: R field is reserved and set to 0.

According to the MAC CE shown in FIG. 3, the P0-PUSCH-Set can be associated with the activated UL or joint TCI state in addition to the pathloss reference RS being associated with the activated TCI codepoint (to which the activated UL or joint TCI state is activated). In addition, some activated TCI codepoint(s) (or some activated UL or joint TCI state(s)) may be associated or not associated with a P0-PUSCH-Set depending on the value of each P_{N} field.

If the association of the pathloss reference RS with the activated TCI codepoint is not configured simultaneously with the association of the P0-PUSCH-Set with the activated UL or joint TCI state, the N^{th} pathloss reference RS ID field(s) may be not included in the MAC CE shown in FIG. 3. In other words, the P0-PUSCH-Set can be associated with a UL or joint TCI state when the UL or joint TCI state is mapped to (or activated to or associated with) a TCI codepoint.

Option 3: Each activated UL or joint TCI state is associated with a P0-PUSCH-Set based on a predetermined order.

Since each activated TCI codepoint is activated with one UL or joint TCI state, the association of the activated UL or joint TCI state with P0-PUSCH-Set can be determined from an association of the activated TCI codepoint (to which the UL or joint TCI state is activated) with P0-PUSCH-Set. Up to 8 TCI codepoints (e.g. TCI codepoint 000, 001, 010, 011, 100, 101, 110 and 111) can be activated with UL or joint TCI state. The activated TCI codepoints can be ordered in an ascending order or descending order. For example, if TCI codepoints 010, 011, 101 and 110 are activated with UL or joint TCI state (i.e., a TCI state is mapped to each of TCI codepoints 010, 011, 101 and 110 as a UL or joint TCI state), the ascending order of the activated TCI codepoints is for example, TCI codepoint 010, TCI codepoint 011, TCI codepoint 101 and TCI codepoint 110, and the descending order of the activated TCI codepoints is for example, TCI codepoint 110, TCI codepoint 101, TCI codepoint 011, TCI codepoint 010.

The configured P0-PUSCH-Sets, based on a predetermined P0-PUSCH-SetId order (e.g. an ascending order of P0-PUSCH-SetIds), can be associated with each of the activated TCI codepoints with UL or joint TCI state in ascending order or descending order.

For example, it is assumed that each of TCI codepoints 010, 011, 101 and 110 is activated with a UL or joint TCI state and each of TCI codepoints 000, 001, 100 and 110 is not activated with any UL or joint TCI state, and at least four P0-PUSCH-Sets (e.g. P0-PUSCH-Set #0 identified by P0-PUSCH-SetId #0, P0-PUSCH-Set #1 identified by P0-PUSCH-SetId #1, P0-PUSCH-Set #2 identified by P0-PUSCH-SetId #2 and P0-PUSCH-Set #3 identified by P0-PUSCH-SetId #3) are configured.

The four P0-PUSCH-Sets in an ascending order (P0-PUSCH-SetId #0, P0-PUSCH-SetId #1, P0-PUSCH-SetId #2, P0-PUSCH-SetId #3) are associated with the activated four TCI codepoints in an ascending order (TCI codepoint 010, TCI codepoint 011, TCI codepoint 100, TCI codepoint 110), respectively. That is,

P0-PUSCH-Set #0 is mapped to (i.e. associated with) TCI codepoint 010,

P0-PUSCH-Set #1 is mapped to (i.e. associated with) TCI codepoint 011,

P0-PUSCH-Set #2 is mapped to (i.e. associated with) TCI codepoint 100, and

P0-PUSCH-Set #3 is mapped to (i.e. associated with) TCI codepoint 110.

If UL-TCI-State #12 is activated for TCI codepoint 010, P0-PUSCH-Set #0 is associated with UL-TCI-State #12.

For another example, if each of TCI codepoints 000, 001, 010, 011, 100, 101, 110 and 111 is activated with UL or joint TCI state, and eight P0-PUSCH-Sets (P0-PUSCH-Set #0 identified by P0-PUSCH-SetId #0, P0-PUSCH-Set #1 identified by P0-PUSCH-SetId #1, P0-PUSCH-Set #2 identified by P0-PUSCH-SetId #2, P0-PUSCH-Set #3 identified by P0-PUSCH-SetId #3, P0-PUSCH-Set #4 identified by P0-PUSCH-SetId #4, P0-PUSCH-Set #5 identified by P0-PUSCH-SetId #5, P0-PUSCH-Set #6 identified by P0-PUSCH-SetId #6 and P0-PUSCH-Set #7 identified by P0-PUSCH-SetId #7) are configured.

The eight P0-PUSCH-Sets in an ascending order (P0-PUSCH-SetId #0, P0-PUSCH-SetId #1, P0-PUSCH-SetId #2, P0-PUSCH-SetId #3, P0-PUSCH-SetId #4, P0-PUSCH-SetId #5, P0-PUSCH-SetId #6, P0-PUSCH-SetId #7) are associated with the activated eight TCI codepoints in an descending order (TCI codepoint 111, TCI codepoint 110, TCI codepoint 101, TCI codepoint 100, TCI codepoint 011, TCI codepoint 010, TCI codepoint 001, TCI codepoint 000), respectively.

P0-PUSCH-Set #0 is mapped to (i.e. associated with) TCI codepoint 111,

P0-PUSCH-Set #1 is mapped to (i.e. associated with) TCI codepoint 110,

P0-PUSCH-Set #2 is mapped to (i.e. associated with) TCI codepoint 101,

P0-PUSCH-Set #3 is mapped to (i.e. associated with) TCI codepoint 100,

P0-PUSCH-Set #4 is mapped to (i.e. associated with) TCI codepoint 011,

P0-PUSCH-Set #5 is mapped to (i.e. associated with) TCI codepoint 010,

P0-PUSCH-Set #6 is mapped to (i.e. associated with) TCI codepoint 001, and

P0-PUSCH-Set #7 is mapped to (i.e. associated with) TCI codepoint 000.

If UL-TCI-State #12 is activated for TCI codepoint 010, P0-PUSCH-Set #5 is associated with UL-TCI-State #12.

If an activated UL or joint TCI state is not associated with any P0-PUSCH-Set, the activated UL or joint TCI state can be assumed to be associated with the P0-PUSCH-Set identified by the lowest P0-PUSCH-SetId (e.g. P0-PUSCH-SetId #0).

The OLPCPSI field contained in DCI format 0_1 or 0_2 can be reused to indicate which P0 value is used (i.e. P0 value can be switched between the P0 value for eMBB and the P0 value(s) for URLLC).

When a configuration of a P0-PUSCH-SetList, i.e. one or multiple (e.g. up to 8) P0-PUSCH-Sets, is provided to the UE, and a P0-PUSCH-Set (either explicitly determined by one of the three options, or implicitly determined as the P0-PUSCH-Set identified by P0-PUSCH-SetId #0) is associated with the indicated UL or joint TCI state, if the DCI format (e.g. DCI format 0_1 or 0_2) includes the OLPCPSI field, the UE determines a value of P0 (e.g. P_{O_UEPUSCH,b,f,c}( ) used for UL power control for PUSCH defined in 3GPP specification TS38.213) as:
the P0 value contained in p0_Alpha_CLIdPUSCHSet that is associated with the indicated UL or joint TCI state if a value of the OLPCPSI field is ‘0’ or ‘00’,
the first P0-PUSCH value in P0-PUSCH-Set that is associated with the indicated UL or joint TCI state if a value of the OLPCPSI field is ‘1’ or ‘01’,
the first P0-PUSCH value in P0-PUSCH-Set (e.g. P0-PUSCH-Set #0) with the lowest P0-PUSCH-SetID value if a value of OLPCPSI field is ‘1’ or ‘01’ and no P0-PUSCH-Set is explicitly associated with the indicated UL or joint TCI state,
the second P0-PUSCH value in P0-PUSCH-Set that is associated with the indicated UL or joint TCI state if a value of the OLPCPSI field is ‘10’,
the second P0-PUSCH value in P0-PUSCH-Set (e.g. P0-PUSCH-Set #0) with the lowest P0-PUSCH-SetID value if a value of OLPCPSI field is ‘10’ and no P0-PUSCH-Set is explicitly associated with the indicated UL or joint TCI state.

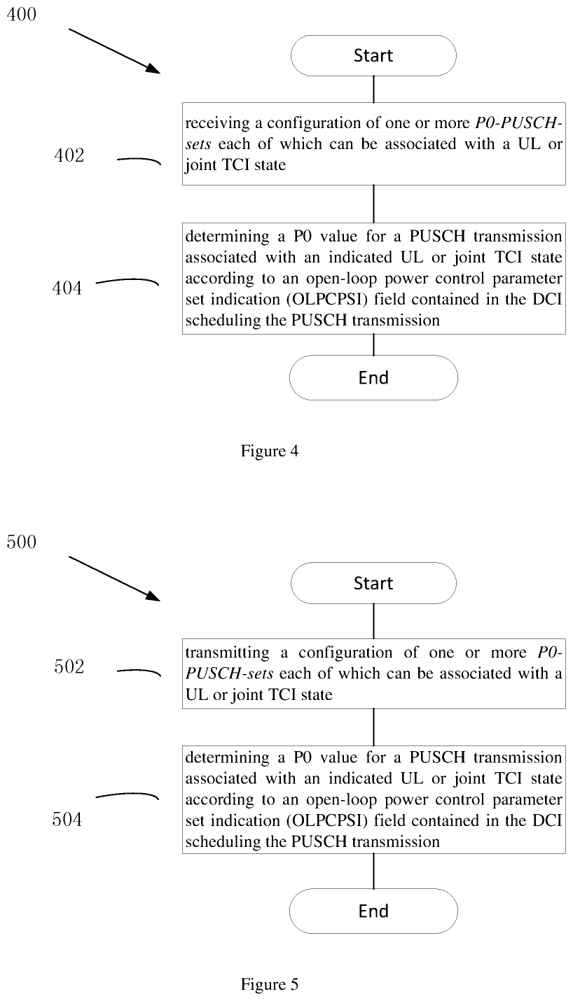

FIG. 4 is a schematic flow chart diagram illustrating an embodiment of a method 400 according to the present application. In some embodiments, the method 400 is performed by an apparatus, such as a remote unit (e.g. UE). In certain embodiments, the method 400 may be performed by a processor executing program code, for example, a microcontroller, a microprocessor, a CPU, a GPU, an auxiliary processing unit, a FPGA, or the like.

The method 400 is a method of a UE, comprising: 402 receiving a configuration of one or more P0-PUSCH-sets each of which can be associated with a UL or joint TCI state; and 404 determining a P0 value for a PUSCH transmission associated with an indicated UL or joint TCI state according to an open-loop power control parameter set indication (OLPCPSI) field contained in the DCI scheduling the PUSCH transmission. The method may further comprise receiving an association of one P0-PUSCH-set to the indicated UL or joint TCI state.

In one embodiment, the association is contained in an RRC signaling.

In another embodiment, the association is contained in a MAC CE. The MAC CE may associate one P0-PUSCH-set to each of the activated UL or joint TCI state(s), and the indicated UL or joint TCI state is indicated from the activated UL or joint TCI state(s). An example MAC CE may include TCI codepoint fields of 8 bits, including N non-zero bit(s), each non-zero TCI codepoint field identifies a TCI codepoint that can be associated with an activated UL or joint TCI state, where N is from 1 to 8; N TCI state ID fields, each of which identifies a UL or joint TCI state associated with one non-zero TCI codepoint field; N P_{N} fields, each of which indicates whether one P0-PUSCH-SetId field corresponding to one P_{N} field is present; and P0-PUSCH-SetId fields, each of which indicates a P0-PUSCH-Set associated with one UL or joint TCI state identified by one TCI state ID field.

In still another embodiment, each TCI codepoint activated with a UL or joint TCI state is associated with one P0-PUSCH-Set based on a predetermined order. Accordingly, the one P0-PUSCH-Set associated with the TCI codepoint is associated with the UL or joint TCI state activated to the TCI codepoint.

In some embodiment, if olpc-ParameterSetDCI-0-1 and olpc-ParameterSetDCI-0-2 are configured to be 1 bit, one value is configured in each P0-PUSCH-Set; and if olpc-ParameterSetDCI-0-1 and olpc-ParameterSetDCI-0-2 are configured to be 2 bits, two values are configured in each P0-PUSCH-Set. In particular, the P0 value is determined by the P0 value contained in p0_Alpha_CLIdPUSCHSet that is associated with the indicated UL or joint TCI state if a value of the OLPCPSI field is ‘0’ or ‘00’, a first value configured in the P0-PUSCH-Set associated with the indicated UL or joint TCI state if a value of the OLPCPSI field is ‘1’ or ‘01’ and the indicated UL or joint TCI state is associated with a P0-PUSCH-Set, a first value configured in the P0-PUSCH-Set with a lowest p0-PUSCH-SetID value if a value of the OLPCPSI field is ‘1’ or ‘01’ and the indicated UL or joint TCI state is not associated with any P0-PUSCH-Set, a second value configured in the P0-PUSCH-Set associated with the indicated UL or joint TCI state if a value of the OLPCPSI field is ‘10’ and the indicated UL or joint TCI state is associated with a P0-PUSCH-Set, and a second value configured in the P0-PUSCH-Set with a lowest p0-PUSCH-SetID value if a value of the OLPCPSI field is ‘10’ and the indicated UL or joint TCI state is not associated with any P0-PUSCH-Set.

FIG. 5 is a schematic flow chart diagram illustrating an embodiment of a method 500 according to the present application. In some embodiments, the method 500 is performed by an apparatus, such as a base unit. In certain embodiments, the method 500 may be performed by a processor executing program code, for example, a microcontroller, a microprocessor, a CPU, a GPU, an auxiliary processing unit, a FPGA, or the like.

The method 500 may comprise 502 transmitting a configuration of one or more P0-PUSCH-sets each of which can be associated with a UL or joint TCI state; and 504 determining a P0 value for a PUSCH transmission associated with an indicated UL or joint TCI state according to an open-loop power control parameter set indication (OLPCPSI) field contained in the DCI scheduling the PUSCH transmission. The method may further comprise transmitting an association of one P0-PUSCH-set to the indicated UL or joint TCI state.

In one embodiment, the association is contained in an RRC signaling.

In another embodiment, the association is contained in a MAC CE. The MAC CE may associate one P0-PUSCH-set to each of the activated UL or joint TCI state(s), and the indicated UL or joint TCI state is indicated from the activated UL or joint TCI state(s). An example MAC CE may include TCI codepoint fields of 8 bits, including N non-zero bit(s), each non-zero TCI codepoint field identifies a TCI codepoint that can be associated with an activated UL or joint TCI state, where N is from 1 to 8; N TCI state ID fields, each of which identifies a UL or joint TCI state associated with one non-zero TCI codepoint field; N P_{N} fields, each of which indicates whether one P0-PUSCH-SetId field corresponding to one P_{N} field is present; and P0-PUSCH-SetId fields, each of which indicates a P0-PUSCH-Set associated with one UL or joint TCI state identified by one TCI state ID field.

In still another embodiment, each TCI codepoint activated with a UL or joint TCI state is associated with one P0-PUSCH-Set based on a predetermined order.

In some embodiment, if olpc-ParameterSetDCI-0-1 and olpc-ParameterSetDCI-0-2 are configured to be 1 bit, one value is configured in each P0-PUSCH-Set; and if olpc-ParameterSetDCI-0-1 and olpc-ParameterSetDCI-0-2 are configured to be 2 bits, two values are configured in each P0-PUSCH-Set. In particular, the P0 value is determined by the P0 value contained in p0_Alpha_CLIdPUSCHSet that is associated with the indicated UL or joint TCI state if a value of the OLPCPSI field is ‘0’ or ‘00’, a first value configured in the P0-PUSCH-Set associated with the indicated UL or joint TCI state if a value of the OLPCPSI field is ‘1’ or ‘01’ and the indicated UL or joint TCI state is associated with a P0-PUSCH-Set, a first value configured in the P0-PUSCH-Set with a lowest p0-PUSCH-SetID value if a value of the OLPCPSI field is ‘1’ or ‘01’ and the indicated UL or joint TCI state is not associated with any P0-PUSCH-Set, a second value configured in the P0-PUSCH-Set associated with the indicated UL or joint TCI state if a value of the OLPCPSI field is ‘10’ and the indicated UL or joint TCI state is associated with a P0-PUSCH-Set, and a second value configured in the P0-PUSCH-Set with a lowest p0-PUSCH-SetID value if a value of the OLPCPSI field is ‘10’ and the indicated UL or joint TCI state is not associated with any P0-PUSCH-Set.

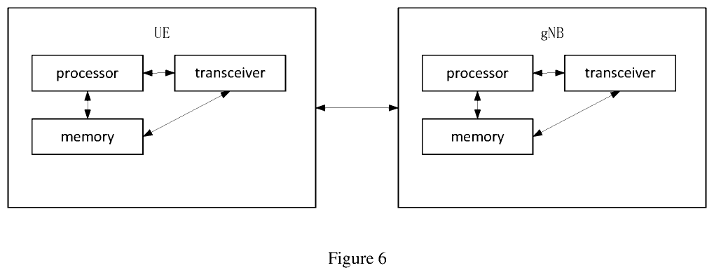

FIG. 6 is a schematic block diagram illustrating apparatuses according to one embodiment.

Referring to FIG. 6, the UE (i.e. the remote unit) includes a processor, a memory, and a transceiver. The processor implements a function, a process, and/or a method which are proposed in FIG. 4.

The UE comprises a processor; and a receiver coupled to the processor, wherein the processor is configured to receive, via the receiver, a configuration of one or more P0-PUSCH-sets each of which can be associated with a UL or joint TCI state; and determine a P0 value for a PUSCH transmission associated with an indicated UL or joint TCI state according to an OLPCPSI field contained in the DCI scheduling the PUSCH transmission. The processor may be further configured to receive, via the receiver, an association of one P0-PUSCH-set to the indicated UL or joint TCI state.

In one embodiment, the association is contained in an RRC signaling.

In another embodiment, the association is contained in a MAC CE. The MAC CE may associate one P0-PUSCH-set to each of the activated UL or joint TCI state(s), and the indicated UL or joint TCI state is indicated from the activated UL or joint TCI state(s). An example MAC CE may include TCI codepoint fields of 8 bits, including N non-zero bit(s), each non-zero TCI codepoint field identifies a TCI codepoint that can be associated with an activated UL or joint TCI state, where N is from 1 to 8; N TCI state ID fields, each of which identifies a UL or joint TCI state associated with one non-zero TCI codepoint field; N P_{N} fields, each of which indicates whether one P0-PUSCH-SetId field corresponding to one P_{N} field is present; and P0-PUSCH-SetId fields, each of which indicates a P0-PUSCH-Set associated with one UL or joint TCI state identified by one TCI state ID field.

In still another embodiment, each TCI codepoint activated with a UL or joint TCI state is associated with one P0-PUSCH-Set based on a predetermined order.

In some embodiment, if olpc-ParameterSetDCI-0-1 and olpc-ParameterSetDCI-0-2 are configured to be 1 bit, one value is configured in each P0-PUSCH-Set; and if olpc-ParameterSetDCI-0-1 and olpc-ParameterSetDCI-0-2 are configured to be 2 bits, two values are configured in each P0-PUSCH-Set. In particular, the P0 value is determined by the P0 value contained in p0_Alpha_CLIdPUSCHSet that is associated with the indicated UL or joint TCI state if a value of the OLPCPSI field is ‘0’ or ‘00’, a first value configured in the P0-PUSCH-Set associated with the indicated UL or joint TCI state if a value of the OLPCPSI field is ‘1’ or ‘01’ and the indicated UL or joint TCI state is associated with a P0-PUSCH-Set, a first value configured in the P0-PUSCH-Set with a lowest p0-PUSCH-SetID value if a value of the OLPCPSI field is ‘1’ or ‘01’ and the indicated UL or joint TCI state is not associated with any P0-PUSCH-Set, a second value configured in the P0-PUSCH-Set associated with the UL or joint TCI state if a value of the OLPCPSI field is ‘10’ and the indicated UL or joint TCI state is associated with a P0-PUSCH-Set, and a second value configured in the P0-PUSCH-Set with a lowest p0-PUSCH-SetID value if a value of the OLPCPSI field is ‘10’ and the indicated UL or joint TCI state is not associated with any P0-PUSCH-Set.

The gNB (i.e. the base unit) includes a processor, a memory, and a transceiver. The processor implements a function, a process, and/or a method which are proposed in FIG. 5.

The base unit comprises a processor; and a transmitter coupled to the processor, wherein the processor is configured to transmit, via the transmitter, a configuration of one or more P0-PUSCH-sets each of which can be associated with a UL or joint TCI state; and determine a P0 value for a PUSCH transmission associated with an indicated UL or joint TCI state according to an OLPCPSI field contained in the DCI scheduling the PUSCH transmission. The processor may be further configured to receive, via the receiver, an association of one P0-PUSCH-set to the indicated UL or joint TCI state.

In one embodiment, the association is contained in an RRC signaling.

In another embodiment, the association is contained in a MAC CE. The MAC CE may associate one P0-PUSCH-set to each of the activated UL or joint TCI state(s), and the indicated UL or joint TCI state is indicated from the activated UL or joint TCI state(s). An example MAC CE may include TCI codepoint fields of 8 bits, including N non-zero bit(s), each non-zero TCI codepoint field identifies a TCI codepoint that can be associated with an activated UL or joint TCI state, where N is from 1 to 8; N TCI state ID fields, each of which identifies a UL or joint TCI state associated with one non-zero TCI codepoint field; N P_{N} fields, each of which indicates whether one P0-PUSCH-SetId field corresponding to one P_{N} field is present; and P0-PUSCH-SetId fields, each of which indicates a P0-PUSCH-Set associated with one UL or joint TCI state identified by one TCI state ID field.

In still another embodiment, each TCI codepoint activated with a UL or joint TCI state is associated with one P0-PUSCH-Set based on a predetermined order.

In some embodiment, if olpc-ParameterSetDCI-0-1 and olpc-ParameterSetDCI-0-2 are configured to be 1 bit, one value is configured in each P0-PUSCH-Set; and if olpc-ParameterSetDCI-0-1 and olpc-ParameterSetDCI-0-2 are configured to be 2 bits, two values are configured in each P0-PUSCH-Set. In particular, the P0 value is determined by the P0 value contained in p0_Alpha_CLIdPUSCHSet that is associated with the indicated UL or joint TCI state if a value of the OLPCPSI field is ‘0’ or ‘00’, a first value configured in the P0-PUSCH-Set associated with the indicated UL or joint TCI state if a value of the OLPCPSI field is ‘1’ or ‘01’ and the indicated UL or joint TCI state is associated with a P0-PUSCH-Set, a first value configured in the P0-PUSCH-Set with a lowest p0-PUSCH-SetID value if a value of the OLPCPSI field is ‘1’ or ‘01’ and the indicated UL or joint TCI state is not associated with any P0-PUSCH-Set, a second value configured in the P0-PUSCH-Set associated with the indicated UL or joint TCI state if a value of the OLPCPSI field is ‘10’ and the indicated UL or joint TCI state is associated with a P0-PUSCH-Set, and a second value configured in the P0-PUSCH-Set with a lowest p0-PUSCH-SetID value if a value of the OLPCPSI field is ‘10’ and the indicated UL or joint TCI state is not associated with any P0-PUSCH-Set.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive a configuration of one or more P0-PUSCH-sets each of which can be associated with an uplink (UL) or joint transmission configuration indicator (TCI) state; and
determine a P0 value for a physical uplink shared channel (PUSCH) transmission associated with an indicated UL or joint TCI state according to an open-loop power control parameter set indication (OLPCPSI) field contained in downlink control information (DCI) scheduling the PUSCH transmission.

2. The UE of claim 1, wherein the at least one processor is further configured to cause the UE to receive an association of one P0-PUSCH-set to the indicated UL or joint TCI state.

3. The UE of claim 2, wherein the association is contained in a radio resource control (RRC) signaling.

4. The UE of claim 2, wherein the association is contained in a medium access control (MAC) control element (CE).

5. The UE of claim 4, wherein the MAC CE associates one P0-PUSCH-set to each activated UL or joint TCI state, and the indicated UL or joint TCI state is indicated from the activated UL or joint TCI state.

6. The UE of claim 5, wherein the MAC CE includes:
TCI codepoint fields of 8 bits, including N non-zero bit, each non-zero TCI codepoint field identifies a TCI codepoint that can be associated with an activated UL or joint TCI state, where N is from 1 to 8;
N TCI state identifier (ID) fields, each of which identifies a UL or joint TCI state associated with one non-zero TCI codepoint field;
N P_{N} fields, each of which indicates whether one P0-PUSCH-SetId field corresponding to one P_{N} field is present; and
P0-PUSCH-SetId fields, each of which indicates a P0-PUSCH-Set associated with one UL or joint TCI state identified by one TCI state ID field.

7. The UE of claim 2, wherein each TCI codepoint activated with a UL or joint TCI state is associated with one P0-PUSCH-Set based on a predetermined order.

8. The UE of claim 2, wherein,
if olpc-ParameterSetDCI-0-1 and olpc-ParameterSetDCI-0-2 are configured to be 1 bit, one value is configured in each P0-PUSCH-Set; and
if olpc-ParameterSetDCI-0-1 and olpc-ParameterSetDCI-0-2 are configured to be 2 bits, two values are configured in each P0-PUSCH-Set.

9. The UE of claim 8, wherein the P0 value is determined by:
a P0 value contained in UL power control parameters set other than pathloss reference signal (PL-RS) that is associated with the indicated UL or joint TCI state, if a value of the OLPCPSI field is ‘0’ or ‘00’;
a first value configured in the P0-PUSCH-Set associated with the indicated UL or joint TCI state, if a value of the OLPCPSI field is ‘1’ or ‘01’ and the indicated UL or joint TCI state is associated with a P0-PUSCH-Set;
a first value configured in the P0-PUSCH-Set with a lowest p0-PUSCH-SetID value, if a value of the OLPCPSI field is ‘1’ or ‘01’ and the indicated UL or joint TCI state is not associated with any P0-PUSCH-Set;
a second value configured in the P0-PUSCH-Set associated with the indicated UL or joint TCI state, if a value of the OLPCPSI field is ‘10’ and the indicated UL or joint TCI state is associated with a P0-PUSCH-Set; and
a second value configured in the P0-PUSCH-Set with a lowest p0-PUSCH-SetID value, if a value of the OLPCPSI field is ‘10’ and the indicated UL or joint TCI state is not associated with any P0-PUSCH-Set.

10. A method performed by a user equipment (UE), the method comprising:
receiving a configuration of one or more P0-PUSCH-sets each of which can be associated with an uplink (UL) or joint transmission configuration indicator (TCI) state; and
determining a P0 value for a physical uplink shared channel (PUSCH) transmission associated with an indicated UL or joint TCI state according to an open-loop power control parameter set indication (OLPCPSI) field contained in downlink control information (DCI) scheduling the PUSCH transmission.

11. A base unit for wireless communication, comprising:
at least one memory; and
at least one processor coupled with the at least one memory and configured to cause the base unit to:
transmit a configuration of one or more P0-PUSCH-sets each of which can be associated with an uplink (UL) or joint transmission configuration indicator (TCI) state; and
determine a P0 value for a physical uplink shared channel (PUSCH) transmission associated with an indicated UL or joint TCI state according to an open-loop power control parameter set indication (OLPCPSI) field contained in downlink control information (DCI) scheduling the PUSCH transmission.

12. The base unit of claim 11, wherein the at least one processor is further configured to cause the base unit to receive an association of one P0-PUSCH-set to the indicated UL or joint TCI state.

13. The base unit of claim 12, wherein the association is contained in a radio resource control (RRC) signaling.

14. The base unit of claim 12, wherein the association is contained in a medium access control (MAC) control element (CE).

15. The base unit of claim 12, wherein each TCI codepoint activated with a UL or joint TCI state is associated with one P0-PUSCH-Set based on a predetermined order.

16. A processor for wireless communication, comprising:
at least one controller coupled with at least one memory and configured to cause the processor to:
receive a configuration of one or more P0-PUSCH-sets each of which can be associated with an uplink (UL) or joint transmission configuration indicator (TCI) state; and
determine a P0 value for a physical uplink shared channel (PUSCH) transmission associated with an indicated UL or joint TCI state according to an open-loop power control parameter set indication (OLPCPSI) field contained in downlink control information (DCI) scheduling the PUSCH transmission.

17. The processor of claim 16, wherein the at least one controller is further configured to cause the processor to receive an association of one P0-PUSCH-set to the indicated UL or joint TCI state.

18. The processor of claim 17, wherein the association is contained in a radio resource control (RRC) signaling.

19. The processor of claim 17, wherein the association is contained in a medium access control (MAC) control element (CE).

20. The processor of claim 17, wherein each TCI codepoint activated with a UL or joint TCI state is associated with one P0-PUSCH-Set based on a predetermined order.
